(19) United States
(12) Patent Application Publication
(10) Pub. No.: US 2018/0202715 A1
(43) Pub. Date: Jul. 19, 2018

(54) FLUID REMOVAL SYSTEM

(71) Applicant: CMP CAN INVEST CO. LTD., DARTMOUTH (CA)

(72) Inventors: JEFFERY RAYMOND MACDONALD, NORTH WILTSHIRE (CA); MORGAN HORACE JOHN MCINTOSH, STRATFORD (CA); REX STACEY MCARTHUR, BOISE, ID (US); STEVEN RANDALL KELLEY, HALIFAX (CA)

(21) Appl. No.: 15/573,324

(22) PCT Filed: May 12, 2016
(86) PCT No.: PCT/CA2016/000140

§ 371 Date: Nov. 10, 2017

Related U.S. Application Data
(60) Provisional application No. 62/160,399, filed on May 12, 2015.

(30) Foreign Application Priority Data
Oct. 26, 2015 (CA) 2,910,181

(51) Int. Cl. F26B 17/04; B65G 27/04

(52) U.S. Cl. CPC F26B 17/045; F26B 5/00; B65G 27/04

(57) ABSTRACT

A fluid removal system for removing fluid from a product stream is described herein. The fluid removal system comprises a table, a permeable conveyor to transport the product stream across a top surface of the table and a plenum disposed below the permeable conveyor to draw the fluid from the product stream through the permeable conveyor. At least one vibration inducing mechanism is mounted to the table to provide vibratory motion directly to the table and indirectly to the conveyor. The table is supported by oscillating mounts that provide oscillatory motion to the table.

### FIELD

The present matter relates to a fluid removal system for removing fluid from a product stream. More particularly, the present matter relates to a fluid removal system used in processing food products.

### BACKGROUND

Shaker conveyors are known to be used to remove fluid from product surfaces. In many food processing applications, it is advantageous to mount a suction plenum onto a shaker conveyor to enhance product drying. However, these configurations often have several disadvantages. For instance, adding suction in the form of a suction plenum typically results in product being held tightly to a top surface of the shaker conveyor. Vibration of the shaker is often not strong enough to overcome this suction. As a result, product sticks to the top surface of the shaker conveyor and fluid is not thoroughly removed. One mechanism to overcome this problem is to introduce a belt conveyor in place of a shaker conveyor. In these configurations, vibrating the conveyor belt can improve fluid removal by the system. However, vibration of the conveyor belt is typically achieved by directly deflecting the conveyor belt from the underside. This can lead to stretching and slipping of the belt. Also, belt conveyors typically suffer from poor product dispersion and unequal vibration across the belt.

U.S. Pat. No. 5,924,217 teaches a liquid removal conveyor system that includes a liquid permeable conveyor belt, a vertically moveable agitator and an air suction plenum. The agitator is positioned below the conveyor belt adjacent to the air suction plenum such that when the agitator moves up and down, liquid on the material on the belt falls off the material onto the belt. As the belt continues to move the material, the material passes over the air suction plenum and liquid is sucked through the belt.

U.S. Pat. No. 5,913,590 teaches a method and apparatus for drying products such as lettuce. Drying is said to be accomplished by subjecting the products to irregular movement through the use of vibration in conjunction with movement of air over the surface of the products. Suction openings are arranged behind the moisture absorbing conveyor to draw moisture off of the products on top of the conveyor after vibration is conducted. Knocking members on a rotating shaft intermittently contact and deflect the conveyor belt in an irregular manner to achieve vibration. As the rotating shaft continues to rotate, the knocking members stop contacting the belt and the tension of the belt results in the belt returning to its original shape.

U.S. Pat. No. 7,065,902 describes a blueberry drying apparatus comprising a wire mesh conveyor belt to allow air flow through the conveyor. Four paddle vibrators are mounted below the top conveyor run. An electrical motor rotates the paddles such that the paddles intermittently contact the conveyor belt to impart a slight vibration through the conveyor belt to the berries. The motors are of a variable speed to control the amount of vibrations generated.

### SUMMARY

A fluid removal system for removing fluid from a product stream is described herein. The fluid removal system comprises a table, a permeable conveyor to transport the product stream across a top surface of the table, and a suction plenum disposed below the permeable conveyor to draw fluid from the product stream through the permeable conveyor. At least one vibration inducing device is mounted to the table to indirectly provide vibratory motion to the permeable conveyor. The table is supported by oscillating mounts and vibrating and oscillating forces provided to the table can break a surface tension between a product and a fluid thereon on the surface of the table. Vibrating and oscillating forces can also disperse the product across the surface of the conveyor to reduce product bunching as it crosses the suction plenum. The conveyor transports the product across the suction plenum as it is vibrated.

Additional aspects of the present invention will be apparent in view of the description which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In order that the subject matter may be readily understood, embodiments are illustrated by way of examples in the accompanying drawings, in which:

FIG. 1 shows a perspective view of a fluid removal system including dashed lines to illustrate a grate and plenum configuration underlying the top surface of the conveyor;

FIG. 2 shows a perspective view of the fluid removal system of FIG. 1 wherein the conveyor belt has been removed to reveal underlying structures;

FIG. 3 shows a side view of a second embodiment of a fluid removal system;

FIG. 4 shows a top view of the fluid removal system of FIG. 3;

FIG. 5 shows a cross-sectional view of the fluid removal system of FIG. 3 along the line A-A shown in FIG. 4;

FIG. 6 shows a cross-sectional view of the fluid removal system of FIG. 3 along the line B-B shown in FIG. 4;

FIG. 7 shows a cross-sectional view of the fluid removal system of FIG. 3 along the line C-C shown in FIG. 4;

FIG. 8 shows a cross-sectional view of the fluid removal system of FIG. 3 along the line D-D shown in FIG. 4;

FIG. 9 shows a top view of an exemplary perforated conveyor to be used in the fluid removal system;

FIGS. 10A and 10B show perspective views of a third embodiment of a fluid removal system with an integrated roller; and

FIGS. 11A and 11B show perspective views of a fourth embodiment of a fluid removal system with an additional layer of vibration isolation.

### DETAILED DESCRIPTION

The fluid removal system described herein combines a vibratory conveyor with a continuous belt conveyor to remove fluid from a product stream. Specifically, a product stream comprising solid particulates (i.e. product) and fluid either on the surface of or adjacent the product is transported by a permeable conveyor belt across a suction plenum disposed under the conveyor belt. Prior to reaching the suction plenum, excess fluid is drawn through the permeable conveyor belt by at least one of gravitational, vibratory and oscillating forces into a drip tray. As the product stream travels across the suction plenum, vibratory motion and oscillating motion are indirectly provided to the conveyor and the product stream to break a surface tension between a surface of the product and the fluid. As this surface tension is broken, fluid is drawn through the permeable conveyor and into the suction plenum. Air entrained fluid in the suction plenum passes through a duct to a separation chamber where fluid can be separated from air and captured for removal or recycle. Air can then pass through a pressure blower and be discharged and/or re-circulated to the fluid removal system.

It should be noted that herein “fluid” refers to any liquid on the surface of or adjacent the product to be removed by the fluid removal system, for example, water and/or oil.

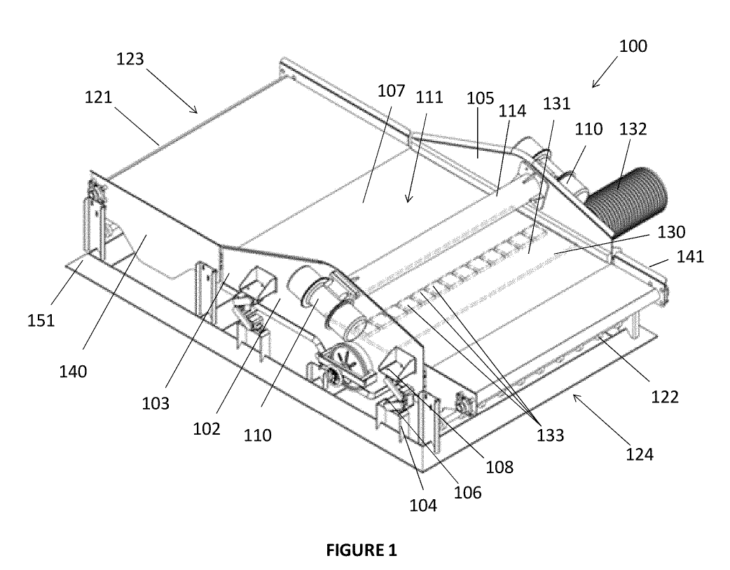

FIG. 1 is a perspective view of one embodiment of fluid removal system 100. Fluid removal system 100 comprises table 102, plenum 131 and flexible tube 132. Plenum 130 is shown as disposed below a top surface 111 of table 102 and is connected to a suction duct (not shown) by flexible tube 132. Beyond the suction duct, a fan, positive displacement blower, turbine, venturi, compressed air flow, or the like provides suction to plenum 131.

In the embodiment shown in FIG. 1, top surface 111 of table 102 is shown as a conveyor 107. Conveyor 107 can be any substantially planar arrangement capable of transporting a product placed thereupon across table 102 from entrance side 123 to exit side 124. For example, conveyor 107 can be a conveyor belt, a set of rollers, a set of interconnected planar sheets, or any other moving belt of proper configuration as required to handle a specific product. Conveyor 107 is also permeable to fluid such that fluid can pass through conveyor 107 to structures disposed below, such as plenum 131. In the embodiment shown in FIG. 1, conveyor 107 is mounted to idler shafts 121,122 located at entrance side 123 and exit side 124, respectively, of table 102.

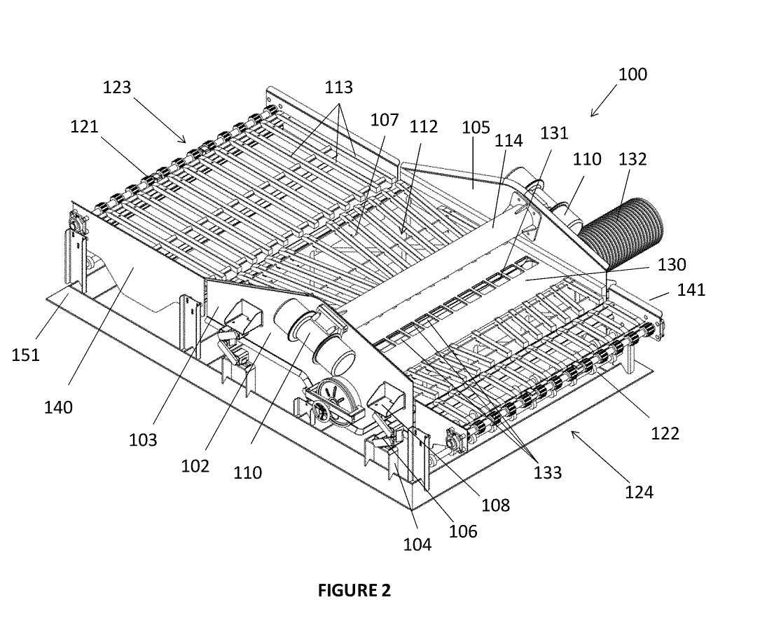

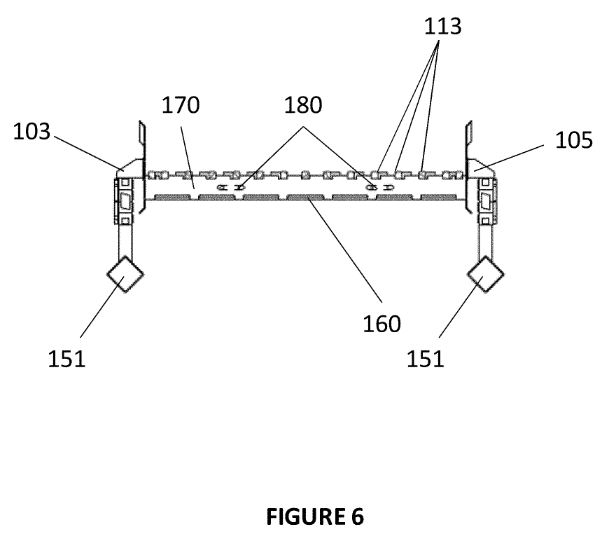

Conveyor 107 is supported by carryway 112 as shown in FIG. 2. FIG. 2 shows carryway 112 as a plurality of support members 113 (see also FIG. 6) extending laterally from opposed sides 123 and 124 to communicate with grate 130 disposed therebetween. In FIG. 2, the plurality of support members 113 comprising carryway 112 are provided in a herringbone pattern, however, carryway 112 can be provided in any structural configuration to suit belting requirements. Support members 113 can provide support to conveyor 107, to a product stream placed on a top surface 111 of conveyor 107 and to table 102 from vibratory and oscillating forces. In the embodiment shown in FIG. 2, a plurality of layers of support members 113 are shown wherein an upper layer of support members 113 provides support to conveyor 107 and a product placed thereupon while a lower layer of support members 113 provides structural support for table 102. Carryway 112 can shear fluid from an underside of conveyor 107 to assist in fluid removal. Further, carryway 112 can provide support to conveyor 107 and provide fluid falling through permeable conveyor 107 to access underlying drip tray 160 (see FIG. 6).

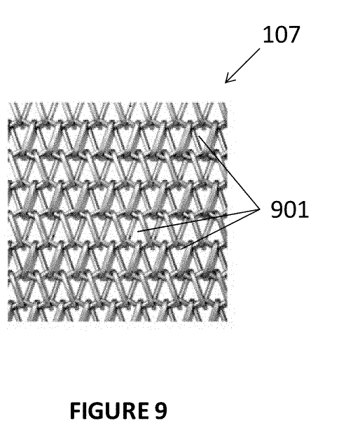

System 100 is typically used to remove fluid from a product stream that is initially placed upon conveyor 107 at a position proximate to entrance side 123, however, a system 100 can also be used to separate fluid from particulate matter or to separate a particulate only product stream. Fluid present in a product stream is typically drawn off of a product therein by passing through perforations 901 (see for example FIG. 9) present in conveyor 107. A diameter of perforations 901 can be customized to selectively permit filtering of particulates as well as fluid. Gravitational forces, vibratory forces and oscillatory forces can all act on a product stream to facilitate movement of fluid and other particulate matter through perforations 901 in conveyor 107 (see for example FIG. 9).

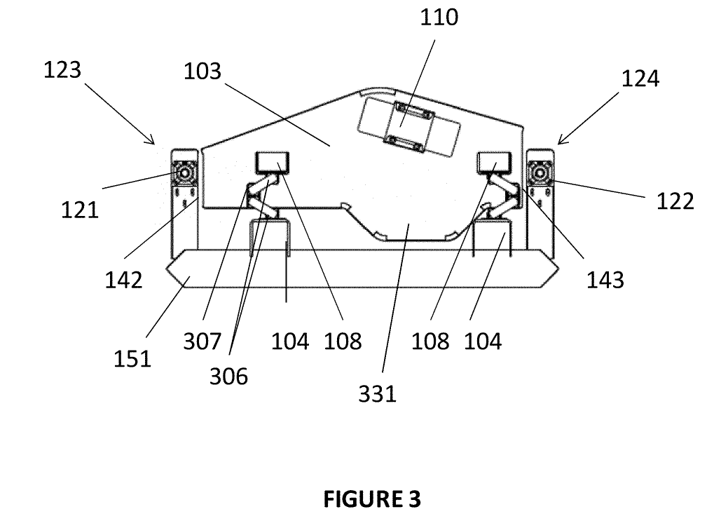

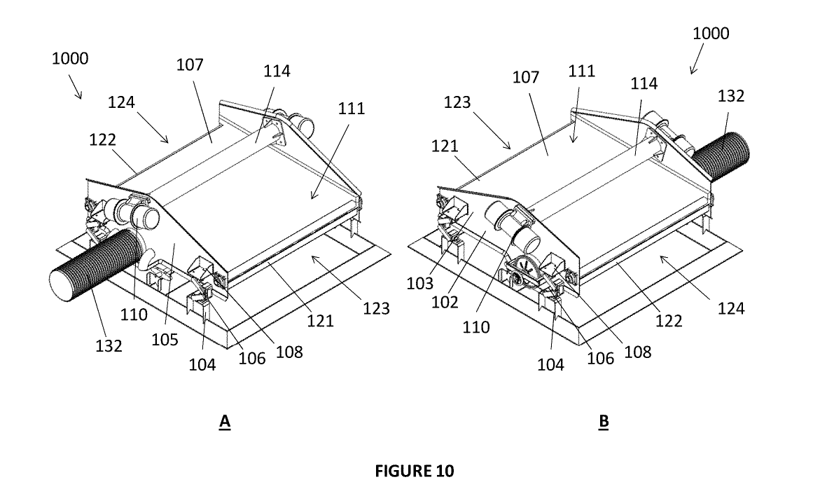

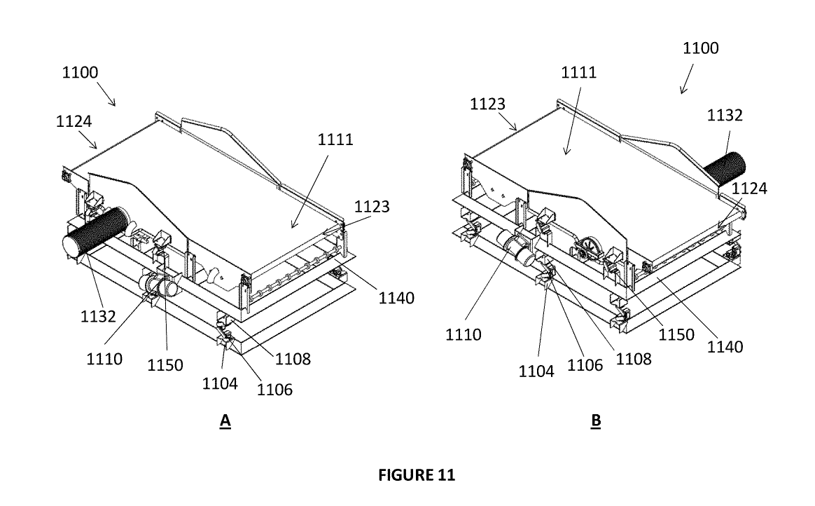

In the embodiment shown in FIGS. 1 and 2, two wings 140 and 141 are shown as coupled to entrance side 123 and exit side 124 of table 102, respectively. Wings 140 and 141 can be used to couple table 102 to other non-vibrating processing systems or apparatuses used to process the product stream. In the embodiments shown in FIGS. 3-8, entrance side 123 and exit side 124 of table 102 are shown as comprising idler shafts 121 and 122, respectively (see FIG. 3). FIGS. 10 and 11 show two additional embodiments of a fluid removal system where idler shafts 121 and 122 are directly coupled to table 102. These embodiments are further described below.

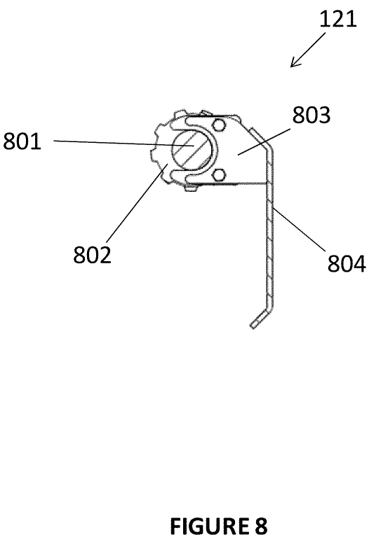

In the embodiment shown in FIGS. 1 and 2, idler shafts 121 and 122 are mounted to wings 140 and 141, respectively. Idler shafts 121 and 122 (i.e. idler shafts) can be coupled to a driving mechanism (not shown) which could be a stainless steel gearbox and a motor, a drum motor, or any other arrangement that results in driving the rotation of idler shafts 121 and 122. The driving mechanism could be located through or under wing 140 or could be integral with rollers 801 (see FIG. 8), for example. Idler shafts 121 and 122 can drive rotation of conveyor 107 at variable speeds. In one embodiment, conveyor 107 can conveyor a product stream thereon at speeds ranging from 3 to 30 feet per minute. Also, the diameter of rollers 801 (ie. roll size) is variable based on width and loading of table 102.

Alternatively, as shown in FIGS. 3 to 8, wings 140 and 141 can be removed from system 100 and idler shafts 121, 122 can be positioned immediately adjacent to entrance side 123 and exit side 124 of table 102. In this configuration, non-vibrating beds can be coupled to entrance side 123 and exit side 124 of table 102 before and after table 102, respectively. Further, idler shafts 121 and 122 could also be mounted onto table 102 along with conveyor 107 and the aforementioned drive mechanism (see FIGS. 10 and 11).

To provide product dispersion and drying of the product stream, system 100 utilizes vibratory motion and oscillating motion. Vibrations and oscillations of table 102 can be independently controlled and operated as described herein.

One example configuration for achieving oscillatory motion and isolating vibrational motion to table 102 is shown in FIGS. 1 and 3. As shown, table 102 is supported by legs 104. FIGS. 1 and 2 show one pair of legs 104 supporting table 102 on a side 103. A second pair of legs 104 also supports table 102 on an opposed side 105. Each leg 104 communicates with a respective element 306 (see FIG. 3) of oscillating mount 106. Oscillating mounts 106 positioned between table 102 and legs 104 insulate vibrational energy induced by vibration inducing devices 110 from legs 104. This insulation focuses vibrational energy induced by vibration inducing devices 110 to table 102 and indirectly to conveyor 107 and the product stream thereupon and lessens vibrational energy lost to legs 104. Each oscillating mount 106 also communicates with an extension 108. Extensions 108 can be integral with and protrude from one of side 103 or opposed side 105 of table 102 to facilitate support by legs 104 and oscillating mounts 106. Extensions 108 can also be manufactured as separate pieces from table 102 and attached in any appropriate manner.

Vibrational motion of table 102 can be achieved through the use of at least one vibration inducing device 110. Sides 103,105 can provide mounting locations for vibration inducing device 110. The number of and power of each vibration inducing device 110 can be based on an amplitude and frequency of vibration that is desired for system 100. For example, frequencies in a range of ˜20 Hz to ˜65 Hz and amplitudes in a range of zero to ˜¾″ could be used for processing product streams using the embodiments discussed herein. In each of the embodiments shown in FIGS. 1 to 11, two vibration inducing devices 110 are provided. In FIG. 1, one vibration inducing device 110 is shown mounted on each of sides 103,105 such that devices 110 are vertically spaced from top surface 111 of table 102. Vibration inducing devices 110 can be positioned anywhere on table 102 to provide vibratory motion to table 102 and indirectly to conveyor 107 and the product stream thereupon. Vibration inducing devices 110 can provide substantially uniform vibratory motion to table 102 by being placed for example at similar but opposed positions on sides 103,105.

Sides 103,105 of table 102 can be manufactured from stainless steel, regular steel, aluminum, or any sufficiently ridged material. In the embodiments shown, stainless steel is used to manufacture sides 103, 105 of table 102. Stainless steel can provide a surface to sufficiently withstand the caustic cleaning and wet environment of, for example, a food processing facility.

There are numerous variations in which to configure oscillating mount 106 such as hinged arms as shown, torsion mounts, shock absorbers, springs (ie. coil and leaf), dog bones, fibers and air mounts. In one non-limiting embodiment (as shown in FIG. 3), each oscillating mount 106 can comprise a hub 307 connecting two elements 306. Hub 307 can be connected to, for example, a motor (not shown) to drive elements 306 towards (i.e. to a ‘closed’ configuration) and away (i.e. to an ‘open’ configuration) from each other in a direction substantially perpendicular to surface 112 to table 102. A rotary electric vibratory motor (not shown) can be used to drive oscillating mounts 306. Oscillatory motion of table 102 can be achieved by alternating ‘opening’ and ‘closing’ of two oscillating mounts 106 on each side 103, 105 of table 102. For example, each oscillating mount 106 as shown in FIGS. 1 to 11 can be simultaneously opened and closed. Repetitive simultaneous opening and closing of oscillating mounts 106 results in oscillatory motion of table 102.

Movement of elements 306 as described can provide oscillatory motion to table 102 and a product stream thereupon. In both embodiments described herein, a plurality of extensions 108 extend substantially perpendicularly to sides 103,105 to communicate with an element 306 of each oscillating mount 108 to support table 102. It should be noted that generation of oscillatory motion by the configuration described is one non-limiting example of generating oscillatory motion for the system 100. Any configuration wherein oscillating mounts provide oscillating motion to table 102 can be used.

Sides 103,105 are substantially parallel to one another and are spaced apart to permit conveyor 107 to be positioned there between. This spacing can be provided by crossing member 114 as shown FIG. 1. Crossing member 114 can also provide support to sides 103,105. Sides 103,105 extend vertically and substantially perpendicularly to top surface 112. Sides 103, 105 can extend vertically such that a portion of each of sides 103, 105 is at a raised position with respect to conveyor 107 and a portion of each of sides 103, 105 is at a lower position with respect to conveyor 107. Sides 103,105

FIG. 1 also shows a platform 151 engaging legs 104. FIGS. 1 and 2 show platform 151 in a diamond-shaped configuration to couple with a lower portion of legs 104. The configuration shown can provide additional support and stability to table 102 by reducing movement of table 102 laterally across a floor. Such lateral motion can be caused by the aforementioned vibratory and oscillatory forces exerted on table 102. The configuration of platform 151 may also improve sanitation by limiting the amount of horizontal surface relative to the ground.

FIG. 2 is a second perspective view of the fluid removal apparatus 100 of FIG. 1 where conveyor 107 has been removed to expose features of fluid removal system 100 underlying conveyor 107.

Plenum 131 is positioned below top surface 111 of table 112 and particularly below grate 130. Plenum 131 communicates with flexible tube 132. Air entrained fluid can be conveyed through a duct (not shown) coupled to a separation chamber (not shown) where fluid can be separated from air and captured for removal or recycle. Air can then be passed through a pressure blower and discharged and/or re-circulated to the fluid removal system.

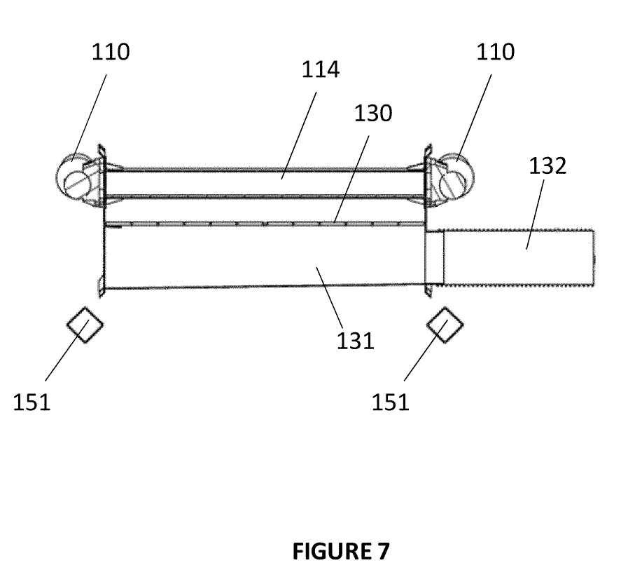

Grate 130 is positioned above plenum 131 and can be made of sufficiently rigid material to support the product stream. Grate 130 comprises apertures 133 which provide access to plenum 131 through which air, fluid and particulate matter from the product stream atop conveyor 107 can travel. Apertures 133 can be sized to selectively provide access to plenum 131. A negative pressure generated by blower/fan attached to plenum 131 and flexible tube 132 can draw fluid and particulate matter sized to pass through apertures 133 into plenum 131. As shown in FIG. 7, plenum 131 can extend substantially across table 102 from opposed side 105 to side 103 to provide substantially uniform suction across conveyor 107. Plenum 131 can be manufactured from stainless steel, plastic, mild steel aluminum, porcelain, or the like.

FIG. 3 shows a side view of a second embodiment of a fluid removal system 100. In this embodiment, optional wings 140, 141 are not shown and idler shafts 121, 122 are positioned at edges 142, 143 of table 102, respectively. As is shown in FIG. 3, idler shafts 121,122 may not be connected to table 102 but rather may be spaced apart from table 102. As previously described, idler shafts 121,122 can also be mounted to table 102.

FIG. 3 also shows that side 103 can be shaped to provide a portion 331 of side 103 to marry with plenum 131. Portion 331 can marry with plenum 131 to provide an air tight seal to achieve efficient suction in plenum 131. FIG. 3 also shows table 102 as positioned on platform 151. Platform 151 can engage legs 104 to provide support to table 102.

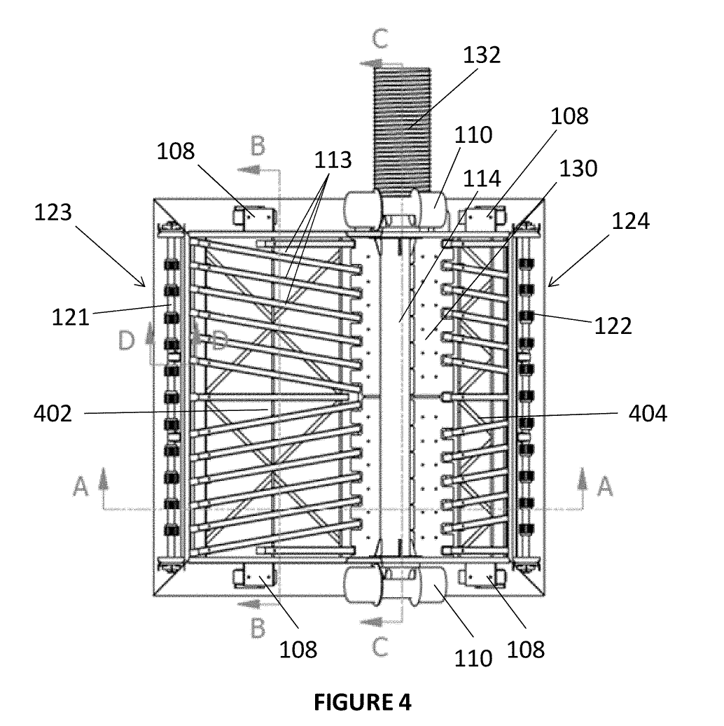

FIG. 4 is a top view of the fluid removal system of FIG. 3 wherein conveyor 107 is not shown. As such, carryway 112 and plenum 131 are exposed. As shown in FIG. 4, carryway 112 can be comprised of a plurality of layers of support members to provide support to conveyor 107 and a product stream placed thereupon.

As shown in FIG. 4, plenum 131 can be positioned between pairs of legs 104 of table 102. FIG. 4 shows plenum 131 positioned proximate to exit side 124 of table 102 such that grate 130 divides carryway 112 into two portions. A larger first portion 402 of carryway 112 is proximate to entrance side 123 while a smaller second portion 404 of carryway 112 is proximate to exit side 124. This configuration may provide more time for a product stream upon conveyor 107 (not shown in FIG. 4) to disperse prior to traversing plenum 131 than if plenum 131 were positioned more proximate to entrance side 123. Increased dispersion of a product stream may lead to more efficient removal of fluid by system 100. Further, vibratory motion generated by vibration inducing devices 110 and oscillatory motion generated by oscillators 108 may improve dispersion of a product stream traversing table 102 from entrance side 123 to exit side 124.

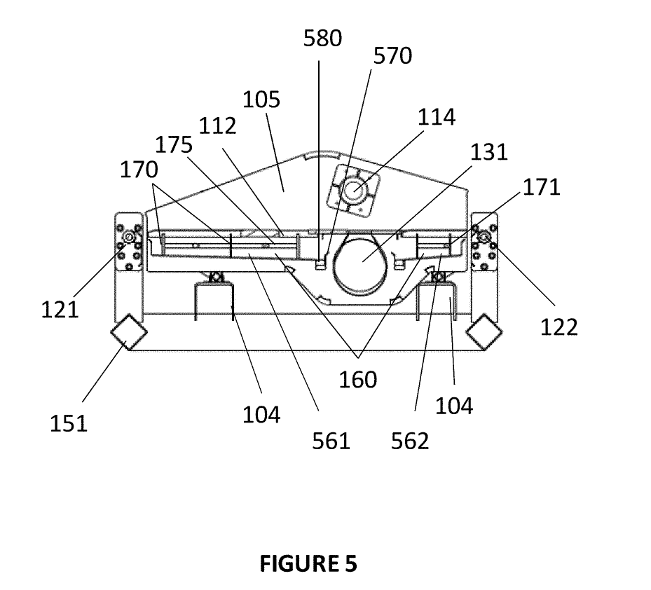

FIG. 5 is a cross-section view of the embodiment of FIG. 3 along line A-A shown in FIG. 4. FIG. 5 shows the position of a drip tray 160 to collect fluid that is drawn off of conveyor 107 by at least one of gravity, vibratory motion and oscillatory motion of table 102. Drip tray 160 can comprise two sections, a first section 561 positioned below first portion 402 of carryway 112 and a second section 562 positioned below a second portion 404 of carryway 112. In one non-limiting example, first section 561 of drip tray 160 can be coupled to carryway 112 by vertical members 170 such that first section 561 is positioned below first portion 402 of carryway 112. Similarly, second section 562 of drip tray 160 can be coupled to carryway 112 by vertical members 171 such that second section 562 is positioned below second portion 404 of carryway 112. Drip tray 160 can be formed from a 10 Ga stainless steel sheet or the like. FIG. 5 also shows a ridge 570 of drip tray 160. Ridge 570 is a side of drip tray 160 that can be used to collect fluid removed from the system 100 by gravity, vibration or oscillation forces prior to transport over plenum 131. Fluid can fall through the permeable conveyor 107 through perforations 901 and into drip tray 160. Fluid can then be drawn by gravity along drip tray 160 and into a trough 580 adjacent to plenum 131 and be piped from the system 100 via gravity.

FIG. 6 is a cross-section view of the embodiment of FIG. 3 along line B-B shown in FIG. 4. FIG. 6 shows carryway 112 comprising a plurality of support members 113 arranged in a plurality of layers. Vertically spaced from and positioned below support members 113 is drip tray 160.

FIG. 7 is a cross-section view of table 102 along line C-C as shown in FIG. 4. FIG. 7 shows plenum 131 and crossing member 114 vertically spaced apart from each other. Plenum 131 is coupled to flexible tube 132 which connects to a blower/fan to establish a negative pressure in plenum 131. The suction force within plenum 131 can be varied as necessary and could be from 1 in water to 30 in water depending on the product. In one example configuration, an industrial stainless steel pressure blower with a wash down duty AC inverter duty motor could provide the suction force to plenum 131.

FIG. 8 is a cross-section view of table 102 along line D-D as shown in FIG. 4. FIG. 8 shows an exemplary idler shaft 121 which comprises a roller tube 801 upon which rollers 802 are positioned. As roller tube 801 rotates (under the driving action of, for example, a motor (not shown)), rollers 802 can contact an underside of conveyor 107 and transfer rotational force thereto to induce movement of conveyor 107. Bracket 803 houses roller tube 801 and mounts roller tube 801 to support 804.

FIG. 9 shows a top view of an exemplary perforated conveyor 107 to be used in the fluid removal system. As previously described, conveyor 107 can be any substantially planar arrangement capable of transporting a product placed thereupon across table 102 from entrance side 123 to exit side 124. For example, conveyor 107 can be a conveyor belt, a set of rollers, a set of interconnected planar sheets, or any other moving belt of proper configuration as required to handle a specific product.

Conveyor 107 is permeable to fluid such that fluid can pass through conveyor 107 to plenum 131 disposed below. Perforations 901 are present in conveyor 107 facilitate movement of fluid through conveyor 107. A diameter of perforations 901 can be customized to selectively permit filtering of other small particulates as well as fluid. Gravitational forces, vibratory forces and oscillatory forces can all act on the product stream to facilitate movement of fluid and other particulate matter through perforations 901 in conveyor 107.

FIGS. 10A and 10B show perspective views of a third embodiment of a fluid removal system 1000 with integrated idler shafts 121, 122. System 1000 shows idler shafts 121,122 as integrated with table 102 such that conveyor 107 is integrated with table 102.

FIGS. 11A and 11B show perspective views of a fourth embodiment of a fluid removal system. System 1100 shows a pan 1140 as separating table 1102 from legs 1104. More specifically, mounts 1150 are positioned between table 1102 and pan 1140 and mounts 1106 are positioned between pan 1140 and legs 1104 to provide a layer of vibration isolation to legs 1104 from vibrational forces induced by vibration inducing devices 1110. Vibration inducing devices 1110 can be mounted to pan 1140 as shown in FIGS. 11A and 11B or can be mounted to a side of table 1102, similarly to as shown in FIG. 1. When mounted onto a side of table 1102, vibration inducing devices 1110 induce a vibrational frequency into table 1102 and indirectly into conveyor 1107. Table 1102 typically has a mass 2-3 times that of pan 1140 as shown in FIGS. 11A and 11B, so as vibrations are indirectly induced into pan 1140, the vibrations are amplified. This amplification may result in lower noise during operation of the system 1100, lower power requirements for vibration inducing devices 1110 and less damaging forces to the system.

In another embodiment (not shown), an area immediately around the system can be shrouded such that air within the area can be circulated and/or filtered to control a temperature of the immediate environment surrounding the system. Controlling the temperature of the immediate environment surrounding the system can permit control of the temperature of the fluid in the system to maintain or control specific properties of the fluid, such as but not limited to viscosity.

### Operation

As a product stream is placed on conveyor 107 of table 102, product stream is transported across table 102 from entrance side 123 towards exit side 124. In one non-limiting example, a product stream for use with system 100 comprises blueberries and water. Movement of conveyor 107 can be provided by a variable speed motor (not shown). In the embodiment shown in FIGS. 1 and 2, a product stream can initially be placed on conveyor 107 proximate to entrance side 123.

System 100 is intended to remove fluid from a product stream placed atop conveyor 107. As such, conveyor 107 is permeable to fluid. As product stream is placed on conveyor 107, gravity will immediately act on the product stream to draw fluid through conveyor 107 onto drip tray 160 positioned below. Drip tray 160 is angularly positioned such that fluid falling onto drip tray 160 can be drawn towards trough 580 and be drained off for reuse or disposal.

As product moves across top surface 111 of table 102 towards plenum 131, vibrational forces and oscillatory forces can be imposed thereupon by vibration inducing devices 110 and oscillatory mounts 106, respectively. Vibratory and oscillatory forces may increase dispersion of the product across conveyor 107 as the product travels from entrance side 123 to exit side 124.

As conveyor 107 moves product from entrance side 123 to exit side 124 it carries product over grate 130 and plenum 131 positioned below grate 131. A suction force provided by blower/fan (not shown) may pull fluid vertically off of a surface of the product down though conveyor belt 107 and grate 130 into plenum 131. After passing over grate 130, product continues moving towards exit side 124. While passing over the plenum/suction, vibration and oscillation forces break the surface tension between the fluid and the product and fluid is drawn off of the product surface by the suction forces of the plenum.

Tables 1 and 2 show the results of a water removal comparison study between a fluid removal system according to an embodiment described herein and a competitor liquid removal conveyor system.

The fluid removal system according to an embodiment described herein featured a permeable conveyor belt mounted on a vibratory table and a suction plenum disposed under the conveyor belt. The permeable conveyor belt carried the product across the suction plenum. To achieve dewatering of the product, the product was indirectly vibrated by the vibratory table as the product passed over the suction plenum.

The competitor liquid removal conveyor system comprised a mesh belt and an air suction plenum disposed beneath the mesh belt. An agitator of the system consisting of a rotatable shaft and a lobe attached to the rotatable shaft was positioned below the mesh belt and adjacent to the plenum. As the product was carried towards the suction plenum on the mesh belt, rotation of the shaft caused the lobe to intermittently deflect an underside of the mesh belt and indirectly jostle the product thereon adjacent to the plenum. The mesh belt then carried the product over the plenum to achieve dewatering of the product.

For each system, product was removed from the product stream feeding the system using a food grade shovel prior to dewatering. The quantity of product removed from the product stream filled a 5 gallon bucket to the top and was subsequently weighed. The product was placed on the respective conveyor belt and carried across the plenum to dewater the product. Using the food grade shovel, the dewatered product was removed from the product stream after crossing the plenum and weighed again. The exact same procedure was performed on both systems with care to avoid all vibration and shaking that could settle the product after removal from the system. The results are presented in Tables 1 and 2.

TABLE 1
Test results of fluid removal system according to an embodiment of the
current application.

| | Pre-dewater | Post-dewater | Pounds of Water |
|---|---|---|---|
| | weight (lbs) | weight (lbs) | Recovered |
| Test 1 | 32.86 | 30.80 | 2.06 |
| Test 2 | 32.61 | 31.41 | 1.20 |
| Test 3 | 32.26 | 30.88 | 1.38 |
| Test 4 | 32.10 | 31.40 | 0.70 |
| Test 5 | 32.20 | 31.11 | 1.09 |
| Test 6 | 31.98 | 31.16 | 0.82 |
| Test 7 | 32.14 | 31.83 | 0.31 |
| Test 8 | 31.29 | 30.01 | 1.28 |
| Test 9 | 33.89 | 29.82 | 4.07 |
| Test 10 | 29.86 | 28.45 | 1.41 |
| Test 11 | 29.59 | 27.58 | 2.01 |
| Test 12 | 32.67 | 32.06 | 0.61 |
| Average | 31.95 | 30.54 | |
| | | Total recovery | 16.94 |
| | | Average recovery | 1.41 |
| | | over 12 tests | |
| | | Normalized | 1.26 |
| | | average recovery | |

TABLE 2
Test results of competitor liquid removal system.

| | Pre-dewater | Post-dewater | Pounds of Water |
|---|---|---|---|
| | weight (lbs) | weight (lbs) | Recovered |
| Test 1 | 31.48 | 30.74 | 0.74 |
| Test 2 | 31.63 | 31.14 | 0.49 |
| Test 3 | 31.88 | 31.01 | 0.87 |
| Test 4 | 31.27 | 30.84 | 0.43 |
| Test 5 | 31.75 | 30.52 | 1.23 |
| Test 6 | 30.88 | 30.90 | −0.02 |
| Test 7 | 30.67 | 31.06 | −0.39 |
| Test 8 | 31.68 | 31.28 | 0.40 |
| Test 9 | 32.74 | 31.78 | 0.96 |
| Test 10 | 32.34 | 32.03 | 0.31 |
| Test 11 | 32.34 | 32.96 | −0.62 |
| Test 12 | 32.87 | 31.94 | 0.93 |
| Average | 31.79 | 31.35 | |
| | | Total recovery | 5.33 |
| | | Average recovery | 0.44 |
| | | Normalized | 0.69 |
| | | average recovery | |

The total amount of water recovered over 12 tests was 218% higher for the fluid removal system according to one of the embodiments described herein when compared to the competitor liquid removal system. When the test results for each system were normalized by removing the tests that produced the highest and lowest individual amounts of water removal and the tests that showed an increase in water from pre-dewatering to post-dewatering, a normalized average recovery of water was calculated from the remaining tests. The normalized average recovery by the fluid removal system according to one of the embodiments described herein was 82% higher than the normalized average recovery by the competitor liquid removal system.

While the foregoing invention has been described in some detail for purposes of clarity and understanding, it will be appreciated by one skilled in the art, from a reading of the disclosure that various changes in form and detail can be made without departing from the true scope of the invention in the appended claims. The scope of the claims should not be limited by the preferred embodiments set forth in the examples, but should be given the broadest interpretation consistent with the description as a whole.

1.-27. (canceled)

28. A fluid removal system for removing fluid from a product stream, the fluid removal system comprising:
a table;
a permeable conveyor to transport the product stream across the table;
a plenum disposed below a portion of the permeable conveyor at a position spaced from an entrance position of the product stream onto the permeable conveyor, the plenum configured to draw the fluid off of a surface of a product of the product stream and through the portion of the permeable conveyor as the product stream passes over the plenum;
at least one vibration inducing mechanism coupled to the table adjacent to the plenum to directly vibrate the table and indirectly vibrate the permeable conveyor and the product stream thereon as the product stream passes over the plenum; and
a plurality of oscillating mounts coupled to support the table and oscillate the table as the product stream passes over the plenum.

29. The system of claim 28, wherein the at least one vibration inducing mechanism is coupled to the table above the plenum.

30. The system of any one of claim 28, wherein the at least one vibration inducing mechanism is coupled to a side of the table.

31. The system of claim 28, wherein the at least one vibration inducing mechanism induces vibrations having a frequency between 20 Hz to 60 Hz and an amplitude of up to 0.75 inches.

32. The system of claim 28, wherein the at least one vibration inducing mechanism is coupled to the table above the permeable conveyor.

33. The system of claim 28, wherein the plurality of oscillating mounts are coupled between the table and legs of the table, the oscillating mounts coupled to a motor to drive the mounts between an open and a closed position to oscillate the table and indirectly the permeable conveyor.

34. The system of claim 34 further comprising a pan mounted between the legs and the table, some of the plurality of oscillating mounts mounting the table to the pan and some of the plurality of oscillating mounts mounting the pan to the legs.

35. The system of claim 35 wherein the table has a mass greater than the pan such that vibrational energy entering the pan reduces at least one of noise, power requirements and damaging forces during operation.

36. The system of claim 28, wherein each of the plurality of oscillatory mounts comprises a hinge.

37. The system of claim 28, wherein the table is simultaneously vibrated and oscillated as the product stream passes over the plenum to break a surface tension between fluid and a product within the product stream such that the fluid is drawn off of the product by suction forces of the plenum.

38. The system claim 28 comprising a drive for driving the permeable conveyor.

39. A fluid removal system for removing fluid from a product stream, the fluid removal system comprising:
a table supported by a plurality of legs, the table coupled to the legs via a plurality of oscillating mounts;
a permeable conveyor to transport the product stream across the table;
a plenum disposed below a portion of the permeable conveyor at a position spaced from an entrance position of the product stream onto the permeable conveyor, the plenum configured to draw the fluid off of a surface of a product of the product stream and through the portion of the permeable conveyor as the product stream passes over the plenum; and
at least one vibration inducing mechanism coupled to the table adjacent to the plenum to directly vibrate the table and indirectly vibrate the permeable conveyor and the product stream thereon as the product stream passes over the plenum; and
wherein the oscillating mounts insulate the legs from vibrational energy induced by the at least one vibration inducing mechanism.

40. The system of claim 39 comprising an oscillation motor to drive the plurality of oscillating mounts between an open position and a closed position thereby to oscillate the table.

41. The system of claim 40 wherein each oscillating mount comprises two arm elements and a hub coupling the two arm elements the hub further coupled to the oscillation motor to drive the two arm elements toward one another to the closed position and away from one another to the open position.

42. The system of claim 40 wherein the oscillation mounts oscillate the table in a direction substantially perpendicular to a surface of the table surface.

43. The system of claim 39 wherein the oscillation motor and at least one vibration inducing mechanism provide simultaneous vibration and oscillation of the product to disperse the product stream over the permeable conveyor and to break a surface tension between the fluid and a product within the product stream, as the product stream passes over the plenum, such that the fluid is drawn off of the product by suction forces of the plenum.

44. The system of claim 43 further comprising a pan mounted between the legs and the table, some of the plurality of oscillating mounts mounting the table to the pan and some of the plurality of oscillating mounts mounting the pan to the legs.

45. The system of claim 44 wherein the table has a mass greater than the pan such that vibrational energy entering the pan reduces at least one of noise, power requirements and damaging forces during operation.

46. A method for removing fluid from a product stream, the method comprising the steps of:
transporting the product stream via a permeable conveyor;
drawing fluid off of a surface of a product of the product stream and through a portion of the permeable conveyor at a position spaced from an entrance position of the product stream onto the permeable conveyor via a plenum disposed below the portion of the permeable conveyor;
directly vibrating a table to which the permeable conveyor is mounted to indirectly vibrate the permeable conveyor and the product stream thereon as the product stream passes over the plenum using at least one vibration inducing mechanism coupled to the table adjacent to the plenum; and
oscillating the table as the product stream passes over the plenum using a plurality of oscillating mounts which support the table, the plurality of oscillating mounts coupled between the table and legs of the table and to a motor which drives the mounts between an open and a closed position to oscillate the table and indirectly the permeable conveyor.

47. The method of claim 46, wherein the at least one vibration inducing mechanism is coupled to the table above the plenum.

48. The method of claim 46, wherein one vibration inducing mechanism is coupled to each of two opposed sides of the table.

49. The method of claim 49, wherein the at least one vibration inducing mechanism induces vibrations having a frequency between 20 Hz to 60 Hz and an amplitude of up to 0.75 inches.

50. The method of claim 46, wherein the at least one vibration inducing mechanism is coupled to the table above the permeable conveyor.

51. The method of claim 46, wherein each of the plurality of oscillatory mounts comprises a hinge.

52. The method of claim 46, comprising simultaneously vibrating and oscillating the table as the product stream passes over the plenum to break a surface tension between fluid and a product within the product stream such that the fluid is drawn off of the product by suction forces of the plenum.

53. The method of claim 46 wherein a pan is mounted between the legs and the table, some of the plurality of oscillating mounts mounting the table to the pan and some of the plurality of oscillating mounts mounting the pan to the legs and wherein the table has a mass greater than the pan such that vibrational energy entering the pan reduces at least one of noise, power requirements and damaging forces during operation.
